(19) United States
(12) Patent Application Publication
(10) Pub. No.: US 2015/0018247 A1
(43) Pub. Date: Jan. 15, 2015

(54) METHOD OF MANUFACTURING BIOMEDICAL MOLECULAR DETECTION PLATFORM AND THE DETECTION PLATFORM MANUFACTURED THEREFROM

(71) Applicant: National Tsing Hua University, Hsinchu (TW)

(72) Inventors: Fan-Gang Tseng, Hsinchu (TW); Shueh-Yao Chu, Hsinchu (TW); Chun-Wei Lee, Hsinchu (TW); Yu-Lin Wang, Hsinchu (TW); Shang-Chi Lin, Hsinchu (TW)

(73) Assignee: National Tsing Hua University, Hsinchu (TW)

(21) Appl. No.: 14/167,310

(22) Filed: Jan. 29, 2014

(30) Foreign Application Priority Data
Jul. 9, 2013 (TW) 102124559

(51) Int. Cl. B01J 19/00

(52) U.S. Cl. CPC B01J 19/0046; B01J 2219/00596; B01J 2219/00603
USPC 506/13; 506/32

(57) ABSTRACT

The present invention provides a method of manufacturing biomedical molecular detection platform, comprising providing a plurality of reagent droplets on a first surface of a substrate; forming a plurality of hydrophilic regions and a water-repellant region on a second surface of a test paper, and the plurality of hydrophilic regions separated individually by the water-repellant region; and contacting the first surface of the substrate with the second surface of the test paper for transferring each reagent droplet on the substrate to each hydrophilic region of the test paper. The present invention also provides a biomedical molecular detection platform manufactured therefrom. The method of present invention can rapidly manufacture large quantity of biomedical molecular detection platforms, and the biomedical molecular detection platform can be used to any test that use pigmentation to determine results.

### CROSS-REFERENCES TO RELATED APPLICATIONS

This application claims priority to Taiwan Patent Application No. 102124559 filed on 9 Jul. 2013. All disclosure of which is incorporated herein by reference in its entirety.

### BACKGROUND OF THE INVENTION

1. Field of the Invention

The present invention is related to a method of manufacturing biomedical molecular detection platform and the detection platform manufactured therefrom; particularly, the present invention is related to a method of commercially manufacturing biomedical molecular detection platform in a large scale and the detection platform manufactured therefrom.

2. The Prior Arts

Many DNA detections need to be done by fluorescent PCR DNA detection, which is the most efficient and accurate detection method among DNA detection techniques. Primers are designed for PCR amplification of the DNA fragments in advance, as the PCR reaction cycles increased sequentially, the target DNA also increased rapidly in scale. Meanwhile, specific fluorescent substances in the PCR reaction solution are able to bind with target DNA, thus producing fluorescent light. However, massive power consuming devices are required and one reaction cycle takes 3 hours, which not only requires expensive equipments but also limits the detection to laboratory-based only.

In aspects such as detection for disease, pH value, cancer, gene, protein, various viruses/bacteria, and analysis for various different human allergens, many usable test agents have been developed; however, due to the inconvenience of liquid formulation of test agents in terms of portability, as well as the problems related to preservation, fixed detection reactions containing detection test agents are thus developed.

Currently, if various different biomedical molecules are to be detected simultaneously, two, five, or even tens of test agents are required. Under this circumstance, many manufacturers will combine them into a single test sheet. Although, this type of test sheet is operationally convenient, the preparation thereof is difficult and complicated, due to the exceeded amount of detection regions and the requirement of different test agents in each detection region. In addition, the time required for the detection will be increased.

Besides, due to the limitations of the known manufacturing methods, the minimum operational amount of the detection test agents and the samples are still in the scale of micro liter (μL). Thus, current technologies are yet able to reduce the amount of test reagent used, while the common pollutions caused by the reagents are to be solved.

### SUMMARY OF THE INVENTION

As to solve the aforementioned problems, the present invention provides a method of manufacturing biomedical molecular detection platform, comprising: (a) providing and maintaining a plurality of reagent droplets on a first surface of a substrate; (b) forming a plurality of hydrophilic regions and a water-repellant region on a second surface of a test paper, and the plurality of hydrophilic regions separated individually by the water-repellant region; and (c) contacting the first surface of the substrate with the second surface of the test paper for transferring each reagent droplet on the substrate to each hydrophilic region of the test paper.

In one embodiment of the present invention, the method further comprising: forming a plurality of reagent droplets on the first surface with a pre-arranged alignment; and forming a plurality of hydrophilic regions on the second surface with the mirror-image of the pre-arranged alignment on the first surface; and forming a plurality of hydrophilic regions and a water-repellant region on the first surface, and each hydrophilic region on the first surface separated individually by the water-repellant region, wherein the reagent droplets are transferred from one or more channels filled with reagents on a plate to the plurality of hydrophilic regions on the first surface.

In another embodiment of the present invention, the reagent droplets formed at the orifice of the feed pipe slide across the first surface of the substrate and form reagent droplets on the hydrophilic regions passed.

In another embodiment of the present invention, the substrate is rolled into a cylinder allowing the first surface of the substrate to contact with the second surface of the test paper by the rolling motion of the cylindrical substrate.

In one embodiment of the present invention, the biomedical molecular detection platform is a test paper.

According to the method of manufacturing biomedical molecular detection platform of the present invention, the test strip can be rapidly produced in a large quantity with simple and easy processes. The uses of the biomedical molecular detection platform is not limited and can be applied to any detection that use pigmentation to determine results, such as the detection of cancer, gene, protein, and various virus/bacteria, and the analysis of different human allergens. Since the test paper is inexpensive and light in weight, it is convenient to store and its cost of transport is low.

The present invention is further explained in the following embodiment illustration and examples. Those examples below should not, however, be considered to limit the scope of the invention, it is contemplated that modifications will readily occur to those skilled in the art, which modifications will be within the spirit of the invention and scope of the appended claims.

### BRIEF DESCRIPTION OF THE DRAWINGS

FIG. 1, illustration of the substrate and the test paper in one embodiment of the present invention.

FIG. 2, illustration of the substrate and the plate in one embodiment of the present invention.

FIG. 3, illustration of using an orifice of feed pipe to form reagent droplets on the substrate in other embodiment of the present invention.

FIG. 4, illustration of using an orifice of feed pipe to form reagent droplets on cylindrical substrate in another embodiment of the present invention.

FIG. 5, illustration of cutting the test paper into strip with detection reagents in one embodiment of the present invention.

### DETAILED DESCRIPTION OF THE PREFERRED EMBODIMENT

### Definition

As used herein, the term “substrate” refers to material capable of supporting associated assay reagents. For example, in some embodiments, the substrate comprises a planar glass, metal, composite, plastic, silica, or other biocompatible or biologically unreactive (or biologically reactive) composition.

As used herein, the term “subject” refers to an individual who will detect one or more test items.

The present invention provides a method of manufacturing biomedical molecular detection platform, comparising: (a) providing a plurality of reagent droplets on a first surface of a substrate; (b) forming a plurality of hydrophilic regions and a water-repellant region on a second surface of a test paper, and the plurality of hydrophilic regions separated individually by the water-repellant region; and (c) contacting the first surface of the substrate with the second surface of the test paper for transferring each reagent droplet on the substrate to each hydrophilic region of the test paper.

Preferably, the biomedical molecular detection platform is a test paper.

In step (a) of the present invention, a substrate 11, a test paper 12, and various reagents to form reagent droplets are prepared.

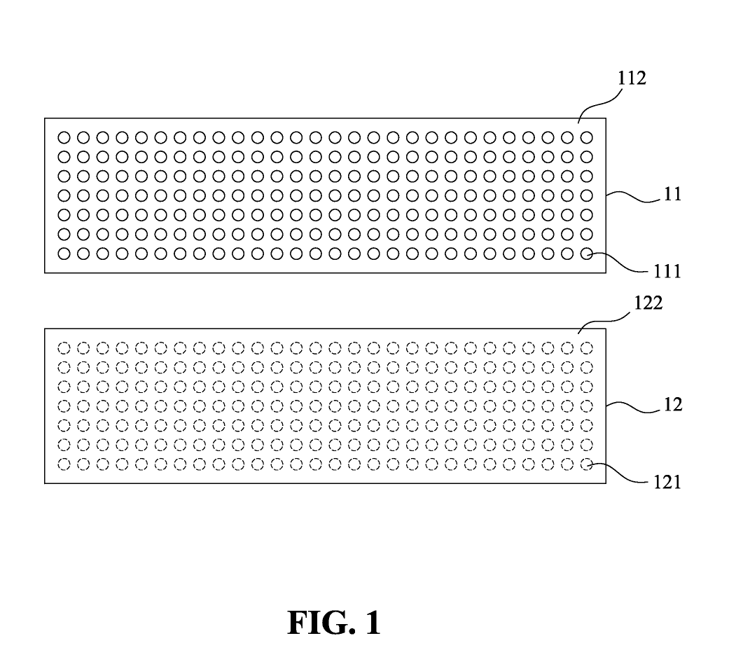

FIG. 1 shows a substrate 11 and a test paper 12. The substrate 11 has a plurality of hydrophilic regions 111 and a water-repellant region 112 on its surface. The water-repellant region 112 surrounds the plurality of hydrophilic regions 111, thus the plurality of hydrophilic regions 111 are separated individually by the water-repellant region 112. Each hydrophilic region 111 includes a reagent droplet with a pre-arranged alignment. In the present invention, the reagent droplet attached in each hydrophilic region 111 arranged along the y-axis are used the same reagent.

In one embodiment of the present invention, the material and thickness of the substrate 11 are not limited, and for example, can include silicon, nylon, or polymer. The substrate 11 and the test paper 12 do not have to be identical in size so long as the hydrophilic regions 111 of the substrate 11 can match with the test paper.

In the present embodiment, a transparent material is used as a substrate 11. The surface of the substrate 11 is cleaned, then spray-dried using jet injector, then placed on heating panel and dried. 1% Teflon is used as the hydrophobic material, coated onto the substrate 11 by spin coating, and placed on heating panel. A metal flake with defined hollow spherical voids is used as mask and underwent plasma etch by argon and oxygen to provide a substrate 11 having spherical shaped hydrophilic regions 111. The diameter of the void of the mask used for the manufacture of substrate 11 is 0.2-10 mm, and the space between each void is 1-20 mm.

In addition, the test paper 12 also has a plurality of hydrophilic regions 121 and a water-repellant region 122. The position of the hydrophilic regions 121 and the water-repellant region 122 on the test paper 12 is the mirror-image of the position of the hydrophilic regions 111 and the water-repellant region 112 on the substrate 11, allowing the reagent droplet attached to each hydrophilic region 111 of the substrate 11 to be precisely transferred and absorbed to each hydrophilic region 121 of the test paper 12. Each hydrophilic region 121 after absorbing a reagent droplet from the substrate 11 may further include a receptor, a peptide, a protein, an antigen, an antibody, an enzyme, a nucleotide, a ligand, or biological or chemical substances of a sample.

In other words, after absorbing the reagent droplet, each hydrophilic region 121 of the test paper 12 becomes a detection region, whereas the water-repellant region 122 of the test paper 12 is a non-detection region. In one embodiment of the present invention, when the diameter of the hydrophilic region 111 of the substrate 11 is 1 mm, the amount of a reagent droplet attached can be down-scaled to about 20 pL.

The test paper 12 used in the present invention are not limited, so long as the test paper 12 exhibits water absorbency and are suitable for the manufacture. Besides, the hydrophobic materials can be coated into the test paper, for example using wax to define the water-repellant region, allowing the test paper to include hydrophilic regions and a water-repellant region.

An example of the hydrophobic material is wax. The test paper 12 having hydrophilic regions and a water-repellant region is prepared in accordance with the following method. A water-repellant region 122 is formed by filling the fiber of the test paper with wax; and each hydrophilic region 121 without wax has the ability of absorbing solutions. To obtain the test paper having a water-repellant region defined with wax, the wax defined region is firstly designed for required by printed test paper, such test paper then be placed on heating panel and heated until wax are spread out across the fiber. After cooling, the test paper having hydrophilic regions and a water-repellant region can be readily used. In the embodiment, the water-repellant region printed is based upon the pattern of the hollow spherical holes. The diameter of the holes is 4-15 mm, and the distance between each hole is 7-20 mm.

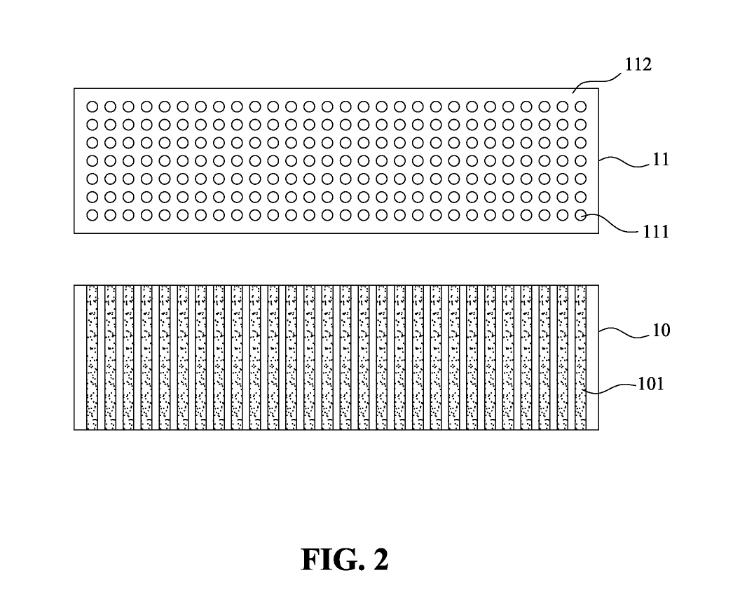

In one embodiment of the present invention, the method of attaching the reagent droplets to the hydrophilic regions 111 of the substrate 11 is demonstrated as follow. As shown in FIG. 2, the reagents filled in channels 101 of the plate 10 are transferred to the hydrophilic regions 111 of the substrate 11. In the present invention, various reagents are different from one another. A transparent material is used as a plate 10. The surface of the plate 10 is cleaned, then spray-dried using jet injector, then placed on heating panel and dried. 1% Teflon is coated onto the plate 10 by spin coating and placed on heating panel. A metal flake with defined hollow spherical voids is used as mask and underwent plasma etch by argon and oxygen to provide the plate 10 having stripped hydrophilic regions 101. In one embodiment of the present invention, the mask used for manufacturing the plate 10 has a width of 3-10 mm, a length of 30-40 mm, and a distance between each channel of 5-10 mm.

The plate 10 has a plurality of channels 101 on its surface. Each channel is filled with one reagent. The positions of channels 101 correspond to the hydrophilic regions 111 of the substrate 11 in the way of mirror-image, allowing precisely transferring of reagent from the channels 101 of plate 10 to the hydrophilic regions 111 of substrate 11 when plate 10 and substrate 11 contact. Besides, each channel 101 corresponds to a plurality of hydrophilic regions 111 to achieve mass production and efficiency.

Similarly, to allow precisely formation of reagent droplets on the hydrophilic regions 111 of the substrate 11, a water-repellant region is a region without channels of plate 10. The water-repellant region is covered with hydrophobic material can be, for example, Teflon, allowing each reagent on the plate 10 to be maintained in each channel 101. The material and thickness of the plate 10 are not limited, and for example, silicon, nylon, or polymer.

The size of test paper 12 and the size, arrangement, or number of hydrophilic regions 121 can be defined according to the test item and the equipment thereof. The number of the test item can be infinitely expanded. Beside, the size, arrangement or number of hydrophilic region/water-repellant region of the substrate 11 also can be adjusted, as well as to the number and width of the channels 101 of the plate 10.

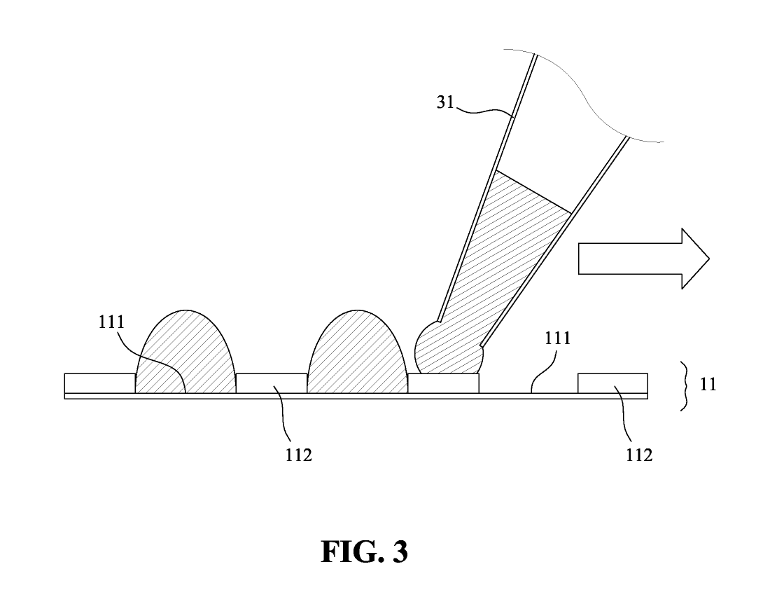

In another embodiment of the present invention, as shown in FIG. 3, the substrate 11 is laid flat. Reagents are filled in the feed pipe 31 firstly and the suitable pressure is controlled allowing reagent droplets to form at the orifice of the feed pipe 31. The hydrophilic regions that require the same reagent are designed in the same row while the position of the feed pipe 31 is fixed. Each hydrophilic region 111 arranged along a direction such as y-axis (the same row) are designed the same reagent while using the feed pipe 31. When the substrate 11 moves along the direction of the arrow in FIG. 3, the reagent droplet slides across the substrate 11 (i.e. the first surface of the substrate 11), then the reagent droplet is attached on the hydrophilic regions 111, whereas the reagent droplet is not attached to the water-repellant region 112. Thus, the plate 11 having different reagent droplets in each row can be accomplished and then underwent the same process to print onto the test paper 12.

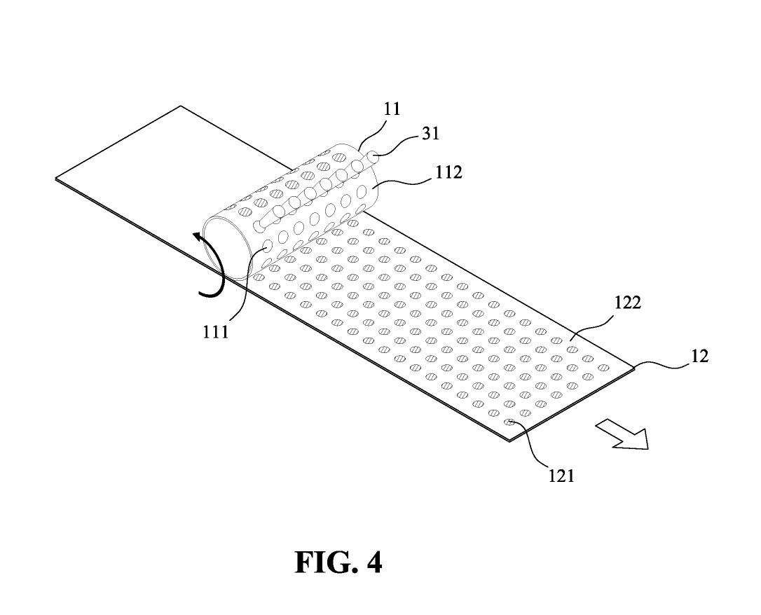

In another embodiment of the present invention, as shown in FIG. 4, the substrate 11 is rolled into a cylinder or covered on the surface of a roller. Reagents are filled in the feed pipe 31 firstly and the suitable pressure is controlled allowing reagent droplets to form at the orifice of the feed pipe 31. When the substrate 11 rolls along the direction of the arrow in FIG. 4, for example, counter-clockwise, the rolling motion of the cylindrical substrate 11 is utilized allowing the surface of the substrate 11 to contact with the surface of the test paper and form reagent droplets on the hydrophilic regions 111 of the substrate 11. The advantage of this manufacturing method is that the cylindrical substrate 11 rolls between the feed pipe 31 and the test paper 12, once the reagent droplets are attached to the hydrophilic regions 111 of the substrate 11 from the feed pipe 31, such rolling motion allows the attached reagent droplets to be absorbed by the fiber in the hydrophilic regions 121 of the test paper 12 below, which results in direct production of the test paper with detection reagents.

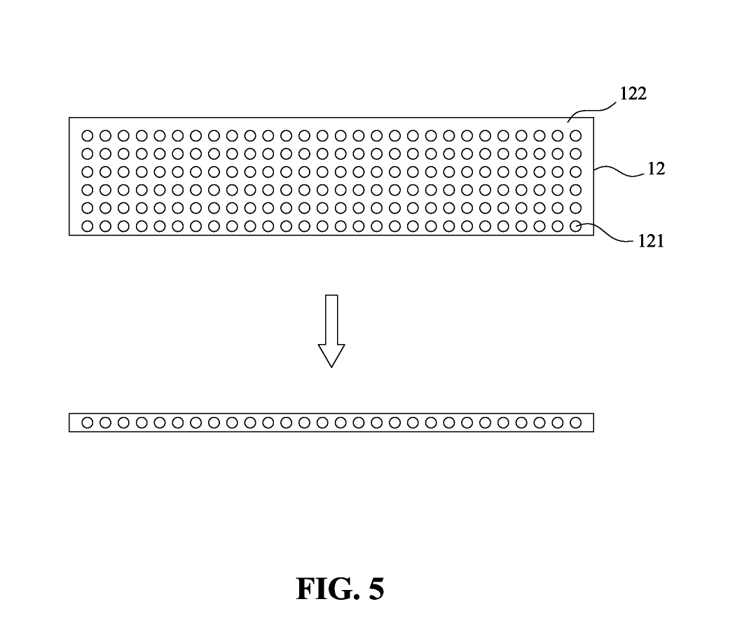

FIG. 5 illustrates a test strip with detection reagents cut from the test paper of the present invention. Each channel 101 is filled with one reagent and each channel 101 is corresponded to, for example, more than ten hydrophilic regions 111, thus providing more than ten subjects to detect the same test item. Therefore, the test strip obtained from an embodiment contains a plurality of detection regions to detect different test items. The test paper of the present invention effectively detects more than ten subjects by once printing and cutting into ten test strips. As a result, the biomedical detection platform manufactured from the method of the present invention can be easily cut and packed into single strip or a number of strips for the application of individual or organizations, which fulfill the purposes of mass production and efficiency.

According to the embodiments hereinbefore, the method of manufacturing biomedical molecular detection platform can rapidly produce biomedical molecular detection platform in a large quantity. The uses of the biomedical molecular detection platform are not limited and can be applied to any detection that uses pigmentation to determine results, such as the detection of cancer, gene, protein, and various viruses/bacteria, and different human allergens.

Furthermore, the method of manufacturing biomedical molecular detection platform of the present invention can not only simultaneously produce a large quantity of biomedical molecular detection platform with various reagents but also efficiently reduce the amount of reagent used, from the scale of micro liter disclosed in the prior arts to the scale of pico liter. The advantage of the present invention is low cost, easy to produce, convenient to store, and environmental friendly. Some areas lack medical resources, in particular, can readily utilize the method of manufacturing biomedical molecular detection platform of the present invention to produce high quality biomedical molecular detection platform.

What is claimed is:

1. A method of manufacturing a biomedical molecular detection platform, comprising:
(a) providing a plurality of reagent droplets on a first surface of a substrate;
(b) forming a plurality of hydrophilic regions and a water-repellant region on a second surface of a test paper, and the plurality of hydrophilic regions separated individually by the water-repellant region; and
(c) contacting the first surface of the substrate with the second surface of the test paper for transferring each reagent droplet on the substrate to each hydrophilic region of the test paper.

2. The method of claim 1, further comprising: forming a plurality of reagent droplets on the first surface with a pre-arranged alignment; and forming a plurality of hydrophilic regions on the second surface with the mirror-image of the pre-arranged alignment on the first surface.

3. The method of claim 1, further comprising: forming a plurality of hydrophilic regions and a water-repellant region on the first surface, and each hydrophilic region on the first surface separated individually by the water-repellant region, wherein the reagent droplets are transferred from one or more channels filled with reagents on a plate to the plurality of hydrophilic regions on the first surface.

4. The method of claim 3, wherein each channel on the plate is filled with one reagent.

5. The method of claim 3, wherein the plate has water-repellant regions to maintain each reagent in each channel.

6. The method of claim 3, wherein each reagent droplet on the substrate is produced by forming each reagent droplet at an orifice of the feed pipe and siding across the substrate and then each reagent droplet is attached on each hydrophilic region of the first surface of the substrate.

7. The method of claim 1, wherein the substrate is rolled into a cylinder allowing the first surface of the substrate to contact with the second surface of the test paper by the rolling motion of the cylindrical substrate.

8. The method of claims 1, wherein a hydrophobic material of the water-repellant region of the substrate is Teflon.

9. The method of claims 2, wherein a hydrophobic material of the water-repellant region of the substrate is Teflon.

10. The method of claims 3, wherein a hydrophobic material of the water-repellant region of the substrate is Teflon.

11. The method of claims 5, wherein a hydrophobic material of the water-repellant region of the substrate is Teflon.

12. The method of claims 6, wherein a hydrophobic material of the water-repellant region of the substrate is Teflon.

13. The method of claims 7, wherein a hydrophobic material of the water-repellant region of the substrate is Teflon.

14. The method of claims 1, wherein wax is used to define the water-repellant region on the test paper.

15. The method of claims 2, wherein wax is used to define the water-repellant region on the test paper.

16. The method of claims 3, wherein wax is used to define the water-repellant region on the test paper.

17. The method of claims 5, wherein wax is used to define the water-repellant region on the test paper.

18. The method of claims 6, wherein wax is used to define the water-repellant region on the test paper.

19. The method of claims 7, wherein wax is used to define the water-repellant region on the test paper.

20. A biomedical molecular detection platform manufactured by the method of claim 1.
